(19) United States
(12) Patent Application Publication
(10) Pub. No.: US 2008/0054128 A1
(43) Pub. Date: Mar. 6, 2008

(54) Muffler Device

(75) Inventors: Anders Ivarsson, Torslanda (SE); Thomas Putter, Vallda (SE)

Correspondence Address: WRB-IP LLP, 1217 KING STREET, ALEXANDRIA, VA, 22314, US

(73) Assignee: VOLVO LASTVAGNAR AB, Goteborg (SE)

(21) Appl. No.: 11/575,503

(22) PCT Filed: Sep. 2, 2005
(86) PCT No.: PCT/SE05/01278

§ 371 Date: Mar. 19, 2007

(30) Foreign Application Priority Data
Sep. 20, 2004 (SE) 0402281-0

(51) Int. Cl. B60K 13/04; F01N 7/18

(52) U.S. Cl. 248/74.3; 248/67.7

(57) ABSTRACT

A device for mounting an oval container on a motor vehicle includes a bracket designed to be mounted vertically on the frame of a vehicle, where the bracket includes an upper arm and a lower arm. The device also includes a mounting unit including a reinforcing beam designed to be mounted on the upper arm, a beam designed to be mounted on the lower arm and at least one strap holder designed to interact with a strap for attaching the said oval container. The reinforcing beam and the beam are permanently attached to the strap holder. A method for mounting an oval container on a vehicle is also disclosed. A simple and space-saving mounting of an oval container on a vehicle can be provided.

### BACKGROUND AND SUMMARY

The present invention relates to a muffler device for a vehicle, in particular a device for supporting and attaching the muffler to the vehicle in the form of at least one bracket permanently attached to the vehicle, provided with means for attaching the muffler to the bracket. The invention also comprises a method for mounting the said muffler on a vehicle.

The most common solution for mounting a muffler, in particular on heavy goods vehicles, is to use a bracket that projects over or under the muffler. The bracket interacts with straps that are attached to the outer ends of the bracket and that, together with the bracket, surround the muffler to attach it to the bracket. For this purpose, the muffler is usually round. With this type of bracket, the bracket requires a lot of space in a vertical direction, which means that the total space for the muffler and bracket can not be utilized effectively. In addition, the requirement for ground clearance limits the space in a downward direction. In addition, circular mufflers have the disadvantage that there is a danger that they will rotate in their fixing, which results in stresses on items attached to the mufflers, for example connecting cables.

In addition, from a purely technical point of view, obtaining sufficient space for mounting, during production, a muffler on a bracket that is to be placed above or below the muffler is complicated. This also means that the working position for the fitter is not ergonomic. In addition, the actual bracket of the said type takes up a relatively large amount of space.

The desire to fulfill legislation relating to emissions for environmental considerations, means that the introduction of catalytic exhaust filtration is increasing within the vehicle industry. This has the result that the components comprised in vehicles must be adapted to meet these new guidelines. In order to obtain exhaust gases with a relatively small amount of chemicals that are harmful to the environment, catalytic exhaust filtration is thus being introduced on increasing numbers of vehicle models. The muffler is therefore equipped with a catalyser and means for after-treatment of exhaust gases, which means that the container requires increased space for housing both muffling and catalytic exhaust filtration. In order to make room for a larger muffler, it is advantageous to utilize the available space more effectively. One way of doing this is to replace the known, bulky brackets with a space-saving bracket. Another way is to give the container a shape that utilizes the available space more effectively.

As a muffler with catalytic exhaust filtration is, in addition, considerably heavier than a conventional muffler, it is also necessary for the bracket to be adapted for this greater weight and for the muffler to be attached to the bracket in an improved way. In addition, an improved method is required for mounting the muffler to the bracket.

It is desirable to obtain a device that makes it possible to mount a container in a space-saving and simple way, so that the available mounting space is utilized in a maximal way and so that, at the same time, the container is held securely in a selected position. It is also desirable to obtain a method for mounting a container on a vehicle in a simple and ergonomic way, so that the available mounting space is utilized in a maximal way.

A device according to an aspect of the present invention comprises a bracket being made single-sided, the bracket being placed along one long side of a container with, in the mounting position, a principally vertical extent and the bracket having a limited size in relation to the container that the bracket is intended to support. The bracket is thus positioned asymmetrically in relation to the container.

According to an aspect of the present invention, a device for mounting an oval container on a motor vehicle is provided, the device comprising a bracket designed to be mounted vertically on the frame of a vehicle, where the bracket comprises an upper arm and a lower arm, with the device also comprising a mounting unit comprising a reinforcing beam designed to be mounted on the upper arm, a beam designed to be mounted on the lower arm and at least one strap holder designed to interact with a strap to attach the said oval container, with the reinforcing beam and the beam being permanently attached to the said strap holder.

The bracket as a whole is thus intended to be positioned along one long side of an oval cylindrical container and the container is attached to the bracket at the places where the container is rounded. As the bracket essentially does not project beyond the extent of the container in a vertical direction, that is above or below the container, the container can be dimensioned so that it is a maximum size while retaining a reliable fixing function. As the container is only attached to the bracket at one long side, the container is simple to mount in the required position and, as a result of the bracket being single-sided, that is as a result of the bracket being positioned asymmetrically in relation to the container, the bracket is also cost-effective as only one bracket is required to support a container. An alternative is to arrange a bracket on both sides of the container for reasons associated with stresses, which would involve higher costs as more brackets would have to be produced and, in addition, more space would be taken up on the goods vehicle.

The bracket is dimensioned in such a way that it does not significantly extend above a plane which coincides with the upper horizontal extent of the container. This is achieved by the upper arm of the bracket being essentially attached to the upper, rounded part of the container.

In addition, the bracket is dimensioned in such a way that it does not significantly extend below a plane which coincides with the lower horizontal extent of the container. This is achieved by the lower arm of the bracket being attached to the lower rounded part of the container.

In order to take up as little space as possible, the bracket is thus only attached to one side of the oval container. The bracket is thus positioned asymmetrically in relation to the container and essentially vertically.

### BRIEF DESCRIPTION OF DRAWINGS

The invention will be described in greater detail in the following, in which:

FIG. 1 shows the current technology,

FIG. 2 shows a bracket according to the invention with container mounted on a vehicle,

FIG. 3 shows a view of a bracket according to the invention with associated container,

FIG. 4 shows a bracket according to the invention without container.

### DETAILED DESCRIPTION

The embodiments of the invention with further developments described in the following are only to be regarded as examples and are in no way to limit the protection provided by the patent claims. In the embodiments described here, the same reference numerals in the different figures refer to the same type of component.

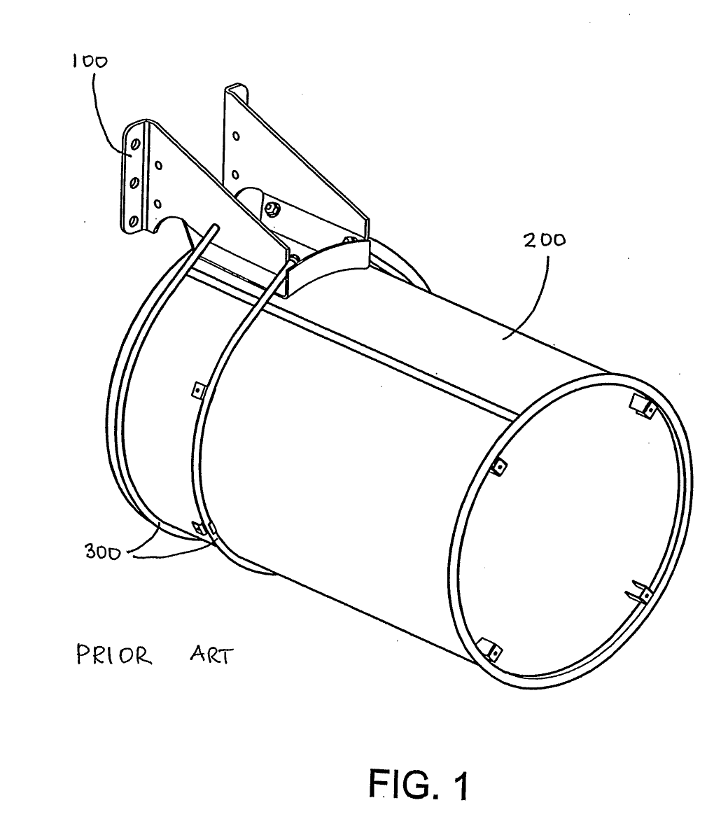

FIG. 1 shows a bracket 100 for attaching to a round muffler of the type that is currently in use. The muffler 200 is supported by a bracket 100 that projects above the muffler 200 and interacts with straps 300 that are attached to the outer ends of the bracket and, together with the bracket 100, surround the muffler 200 to attach this to the bracket 100.

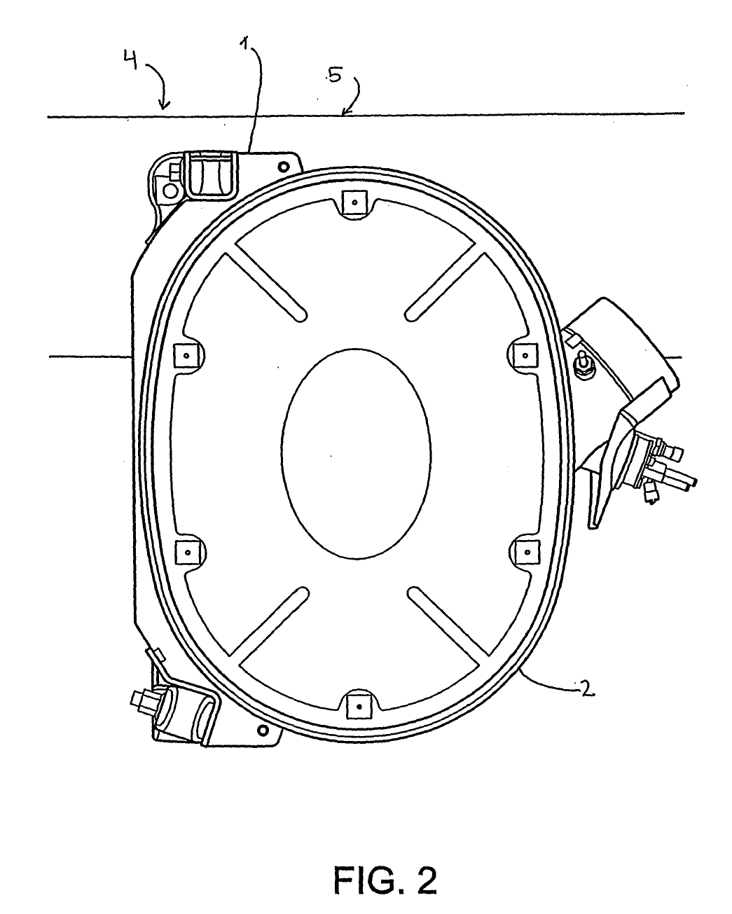

FIG. 2 shows a part of the side 4 of a heavy goods vehicle with a bracket 1 and an oval, cylindrical container 2 mounted in the bracket 1, which container contains muffler and catalyser and means for after-treatment (not shown). The bracket 1 is essentially mounted vertically with an upper arm and a lower arm, in which arms the container 2 is attached. The bracket 1 is attached at its upper part to the frame 5 of the vehicle, preferably by means of bolts. The lower part of the bracket 1 hangs freely in relation to the vehicle. According to this figure, the side 4 of the goods vehicle constitutes a part of the right side of the goods vehicle, viewed in the vehicle's direction of travel. The bracket 1 is single-sided, that is it is arranged along one long side of the container, and is mounted behind the container 2 viewed in the direction of travel. In the part of the frame 5 on which the bracket 1 is mounted, it is assumed that there is also room for bolts at the back of the frame 5. According to FIG. 2, due to a lack of space, the bracket 1 is mounted behind the container 2. In a different application, it could be possible to position the bracket 1 on the opposite side of the container 2, that is in front of the container, viewed in the direction of travel, according to FIG. 2.

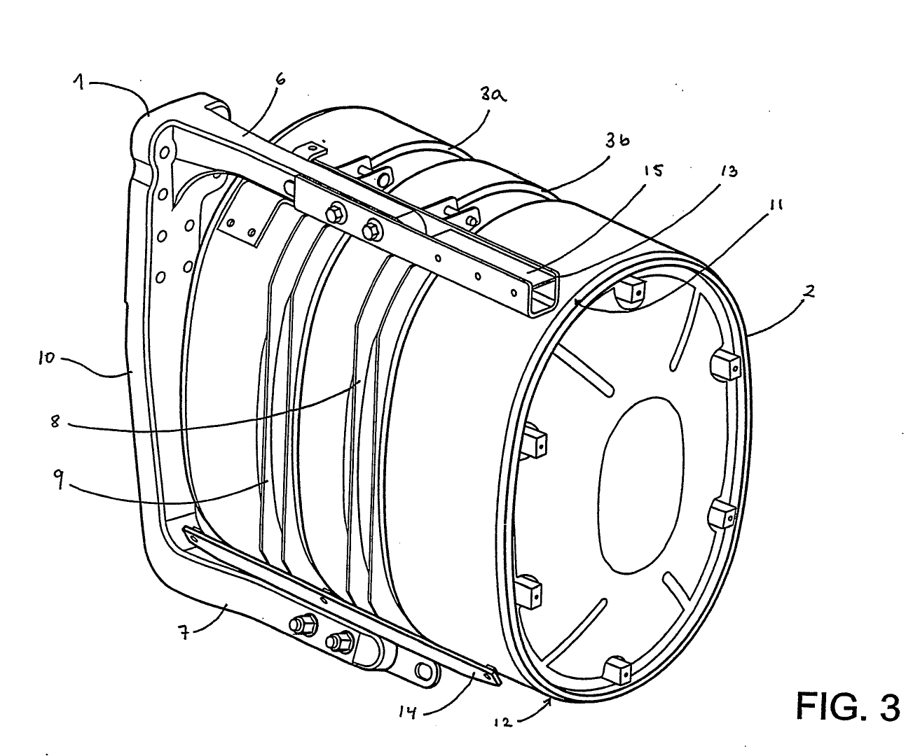

The container 2 comprises a cylinder with an oval casing with an opening in each essentially flat end of the casing. The oval shape means that the container 2 has rounded parts, see for example 11 and 12 in FIG. 3. The container 2 is mounted on the bracket 1 at one long side of the container 2.

The container 2 is mounted on the bracket 1 at one upper rounded part of the container 2, which is advantageous as far as space is concerned and also provides ergonomic advantages when mounting the container 2 in the bracket 1. As shown by the figure, the bracket 1 and container 2 form a compact unit that is small in volume, in order to make it possible to mount other parts comprised in the goods vehicle.

FIG. 3 shows a bracket 1 in which the container 2 is mounted. The container 2 is attached to the bracket 1 at the upper rounded part 11 of the container and at the lower rounded part 12 of the container in such a way that the bracket does not project significantly beyond the extent of the container 2 in a vertical direction. For example, it is proposed that the bracket 1 should not project more than 15 mm above and 5 mm below the container 2. In a lateral direction, it is proposed that the bracket should not project more than 5 mm beyond the container.

In the vertical mounting position, the bracket 1 comprises an upper arm 6 and a lower arm 7 with a linking part 10 between these two arms 6, 7. The linking part 10 has bolt holes in its upper part with room for bolts for mounting in the frame 5, see FIG. 2. In order to make it stronger, the linking part 10 of the bracket 1 is, in addition, designed with a slightly wider upper part and a narrower lower part. Two strap holders 8, 9 are mounted between the projecting arms 6, 7 of the bracket in order to ensure that the construction is sufficiently robust. These strap holders 8, 9 follow the outside of the container 2 and are attached to the upper arm 6 and lower arm 7 of the bracket 1 in such a way that the strap holders 8, 9 run essentially parallel to the linking part 10 of the bracket 1. The strap holders 8, 9 also help to clamp the container 2 to the bracket 1. As the strap holders 8, 9 run along the container 2, they also prevent the container 2 from being able to rotate in its fixing and the strap holders 8, 9 have thereby also a stabilizing effect. In the solution according to the invention, the requirement for strength is greater than in the current solutions as the container 2 is arranged asymmetrically on the bracket 1. The container 2 is fixed to the bracket 1 by means of the strap holders 8, 9 and the straps 3a, 3b.

A reinforcing beam 13 is mounted on the upper arm 6 of the bracket 1. The strap holders 8, 9 are mounted on this reinforcing beam 13, for example by welding. A beam 14 is similarly mounted on the lower arm 7 of the bracket 1, to which beam the strap holders 8, 9 are mounted, for example by welding. The reinforcing beam 13 is intended to be used to attach the container 2 to the bracket. It can also be used as a holder for, for example, radiating elements and/or damping elements that are attached to the reinforcing beam 13. In the embodiment shown, the reinforcing beam 13 is a U-shaped beam and in order to prevent the flanges in the U-shaped beam being pressed together by the stresses, the reinforcing beam 13 has been stabilized with a plate 15 that has been welded to the flanges, see FIG. 3. The lower beam 14 is also intended to be used to attach the container to the bracket. In the embodiment shown, the beam 14 is slightly angled, among other things in order to make mounting the container easier.

The strap holders 8, 9, the reinforcing beam 13 and the beam 14 together constitute a unit defined as a mounting unit 16.

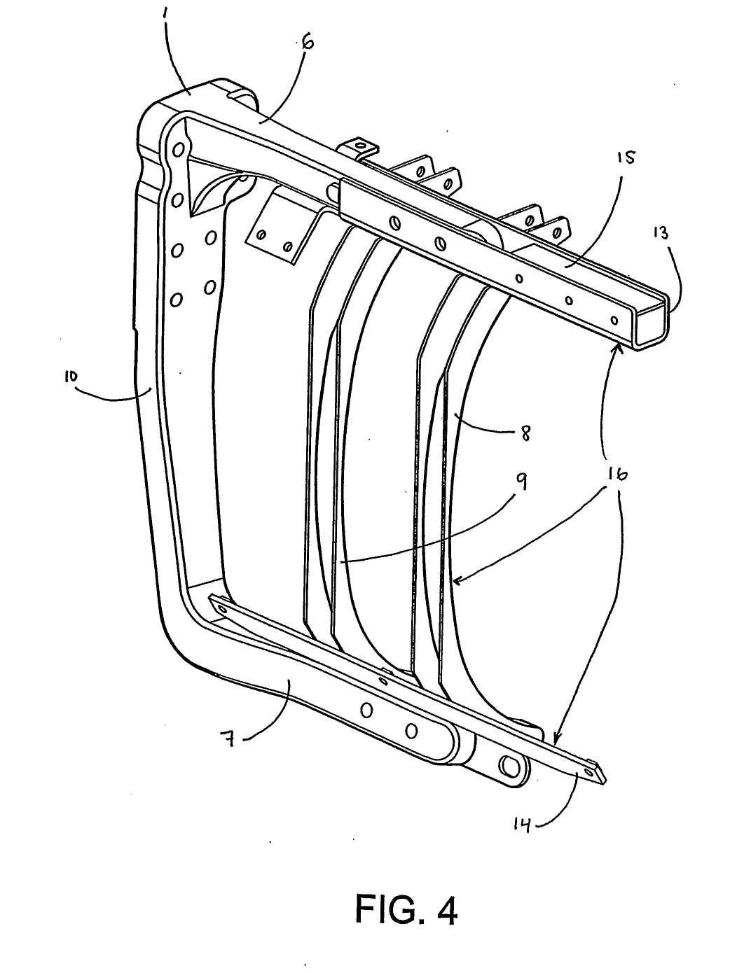

FIG. 4 shows a bracket 1 according to the invention without a mounted container 2. In the vertical mounting position, the bracket 1 comprises an upper arm 6 and a lower arm 7 with a linking part 10 between these two arms 6, 7. The upper part of the linking part 10 is mounted on the frame 5 of the vehicle, see FIG. 2. The fixing area of the bracket 1 is thus positioned in the vicinity of the upper arm 6. The upper part of the linking part 10 is constructed somewhat more robustly than its lower part in order to cope with the stresses in the mounted upper part. The reinforcing beam 13 is joined to the strap holders 8, 9, for example by welding. Similarly, the beam 14 is joined to the strap holders 8, 9, for example by welding. The reinforcing beam 13, the strap holders 8, 9 and the beam 14 constitute a unit defined as a mounting unit 16. The straps 3a, 3b are attached to the strap holders 8, 9 and are tightened so that the container 2 is clamped against the strap holders 8, 9 in a predefined way. The mounting unit 16 comprises positioning means designed to position the mounting unit 16 in relation to the bracket 1 in a predefined way prior to the mounting unit being attached with fixing elements, for example bolts. In addition, the mounting unit 16 is designed to be mounted on the bracket 1 in a plane at right angles to the mounting plane of the bracket.

The method according to the invention for mounting the muffler on the goods vehicle comprises the following four main steps:

1. The bracket 1 is mounted vertically on the frame 5 of the goods vehicle by means of bolts. These advantageously pass through a matching pattern of holes in the frame.

2. Irrespective of when this first step is carried out, the upper parts of the strap holders 8, 9 are welded onto the reinforcing beam 13 in such a way that the parts form an angle of approximately 90 degrees in relation to each other. The lower parts of the strap holders 8, 9 are welded to the beam 14, which is slightly angled. These parts are also welded in such a way that they form an angle of approximately 90 degrees in relation to each other. The strap holders 8, 9 together with the reinforcing beam 13 and the beam 14 together define a unit called a mounting unit 16.

3. The container 2 is offered up to the mounting unit 16 comprising strap holders 8, 9, reinforcing beam 13 and beam 14. The container 2, that has an oval cylindrical shape, is placed in such a way that its one long side is in contact with both the strap holders 8, 9. Straps 3a, 3b are attached to the strap holders 8, 9 and are tightened in such a way that the container 2 is clamped against the strap holders 8, 9 in a predefined way. 4. The mounted unit comprising strap holders 8, 9, with straps 3a, 3b, reinforcing beam 13, beam 14 and container 2, is thereafter offered up to the bracket 1 and pushed onto the bracket in a direction that is at right angles to the mounting plane of the bracket. The mounted unit, that is the mounting unit 16 with container 2 mounted by the straps, is thereafter attached to the upper arm 6 and lower arm 7 of the bracket by means of suitable fixing elements, for example bolts.

In an embodiment of the invention, the mounting unit 16 is self-fixing in relation to the container 2. By this is meant that after it has been placed in a predefined position, the container maintains its position without external forces being applied to the container 2, so that the container 2 maintains its position before it is attached using the fixing elements. The self-fixing is achieved by the inclining of the beam 14 and the design of the beam 13 and by positioning means arranged on the mounting unit 16. In this embodiment, the container 2 is thus positioned on the bracket 1 by the positioning means in a predefined way prior to the mounting unit 16 being attached by the fixing elements.

By means of the arrangement described above, an effective and reliable fixing of a container 2 is made possible, which in combination with the fixing function is optimized as far as volume is concerned as a result of the vertically-mounted bracket 1 only being mounted along one long side of the container 2 and, in addition, not projecting significantly beyond the container 2, whereby the container can be dimensioned to utilize the available space in the vehicle in a maximal way.

In addition, a method is obtained for mounting a container 2 on a vehicle in a simple and reliable way by first mounting the container 2 in a mounting unit 16 and clamping the container with straps and thereafter inserting this unit, containing the mounting unit 16 and container with straps, in a bracket 1 mounted on the frame 5 of the vehicle.

The invention is not to be restricted to the bracket being single-sided, that is with the container being mounted in a bracket at only its one long side. A double-sided bracket, that is with the container being mounted in a bracket along each of its two long sides, is another mounting option. In addition, the container can be designed for other purposes than for muffling and catalytic exhaust filtration. For example, the bracket can be used for mounting an air tank, fuel tank and urea tank or any other type of tank.

1. A device for mounting an oval container on a motor vehicle, comprising;
a bracket adapted to be mounted vertically on the frame of a vehicle, the bracket comprising an upper arm and a lower arm;
a mounting unit comprising a reinforcing beam adapted to be mounted on the upper arm, a beam adapted to be mounted on the lower arm and at least one strap holder adapted to interact with a strap for attaching the oval container, where the reinforcing beam and the beam are permanently attached to the strap holder.

2. The device as claimed in claim 1, wherein a fixing area of the bracket is positioned proximate the upper arm.

3. The device as claimed in claim 1, wherein the mounting unit comprises positioning means adapted to position the mounting unit in relation to the bracket in a predefined way prior to the mounting unit being mounted on the bracket with fixing elements.

4. The device as claimed in claim 1, wherein the mounting unit adapted to be mounted on the bracket in a plane at right angles to a mounting plane of the bracket.

5. A method for mounting an oval container on a motor vehicle, comprising;
mounting a bracket comprising an upper arm and a lower arm vertically on a frame of a vehicle;
mounting a container on a mounting unit comprising a reinforcing beam, a beam and at least one strap holder with at least one strap;
pushing the mounting unit with mounted container onto the bracket in a direction that is at right angles to a mounting plane of the bracket; and
fixing the mounting unit to the bracket with fixing elements.

6. The method as claimed in claim 5, comprising positioning the container on the bracket by positioning means in a predefined way prior to attaching the mounting unit to the bracket with fixing elements.

7. The device as claimed in claim 2, wherein the mounting unit comprises positioning means adapted to position the mounting unit in relation to the bracket in a predefined way prior to the mounting unit being mounted on the bracket with fixing elements.

8. The device as claimed in claim 2, wherein the mounting unit is adapted to be mounted on the bracket in a plane at right angles to a mounting plane of the bracket.

9. The device as claimed in claim 3, wherein the mounting unit is adapted to be mounted on the bracket in a plane at right angles to a mounting plane of the bracket.

10. The device as claimed in claim 7, wherein the mounting unit is adapted to be mounted on the bracket in a plane at right angles to a mounting plane of the bracket.
